(19) United States
(12) Patent Application Publication
(10) Pub. No.: US 2024/0416284 A1
(43) Pub. Date: Dec. 19, 2024

(54) MEMBRANE PURIFICATION OF HYDROGEN PEROXIDE

(71) Applicant: Arkema France, Colombes (FR)

(72) Inventor: Sebastien LOGETTE, PIERRE-BENITE CEDEX (FR)

(21) Appl. No.: 18/708,676

(22) PCT Filed: Nov. 16, 2022
(86) PCT No.: PCT/FR2022/000114

§ 371 Date: May 9, 2024

(30) Foreign Application Priority Data
Nov. 17, 2021 (FR) FR2112122

(51) Int. Cl. B01D 61/02; B01D 71/68; C01B 15/013

(52) U.S. Cl. CPC B01D 61/025; B01D 71/68; C01B 15/013

(57) ABSTRACT

The present invention relates to the use, for the purification of a hydrogen peroxide solution, of a reverse osmosis filtration membrane, said membrane comprising at least one active layer of a polyethersulfone-type polymer.

The present invention also relates to the process for purifying a hydrogen peroxide solution, by passing through a reverse osmosis filtration membrane, said membrane comprising at least one active layer of a polyethersulfone-type polymer.

The present invention relates to the field of purification of hydrogen peroxide (H₂O₂) solutions and more particularly to the field of membrane purification of hydrogen peroxide, and more specifically to the field of membrane purification of hydrogen peroxide by reverse osmosis.

The purification of hydrogen peroxide by reverse osmosis has numerous advantages, among which mention may be made of obtaining hydrogen peroxide, and more specifically aqueous hydrogen peroxide solutions, of very high purity, and in particular having a degree of purity compatible with the technical and industrial fields which require hydrogen peroxide of very high purity and in particular the electronics, pharmaceutical and cosmetics fields, and also the agri-food field.

Reverse osmosis purification technology is described, for example, in document EP0930269 which relates to an industrial process for the production of high-purity hydrogen peroxide by reverse osmosis using a membrane made of polyamides, polypiperazinamides, polyacrylonitriles or polysulfones. Documents EP1520839 and U.S. Pat. No. 4,879,043 also mention the use of such membranes for the reverse osmosis purification of hydrogen peroxide solutions.

However, it turns out that the membranes used for the production of high-purity hydrogen peroxide usually have relatively short lifetimes, of the order of around thirty days, in continuous operation mode. This problem of very short lifetime is mainly observed when the membranes have a polyamide-based active layer.

The rapid degradation of polyamide membranes is now well known and is the subject of numerous works and publications, such as, for example, the study conducted by R. Abejon et al. (“Effective Lifetime Study of Commercial Reverse Osmosis Membranes for Optimal Hydrogen Peroxide Ultrapurification Processes”, Ind. Eng. Chem. Res., (2013), 52, 17270-17284), in which the various advantages and disadvantages of the processes for preparing electronic grade hydrogen peroxide which use membranes based on polyamide (PA) or cellulose acetate (CA) are analyzed.

Current industrial reverse osmosis membranes usually consist of a thin layer of polyamide (generally less than 200 nm) deposited on a porous layer of polyethersulfone (PES) or polysulfone (PS) (of around 50 μm), itself on top of a support sheet, for example made of nonwoven fabric. The three-layer configuration gives the desired properties of high rejection of unwanted materials (such as salts), high filtration rate and good mechanical strength. The polyamide top layer is responsible for the high rejection and is chosen mainly for its permeability to water and its relative impermeability to various dissolved impurities, including salt ions and other small non-filterable molecules.

This rapid degradation of the membranes, and in particular of polyamide-based membranes, results from the rapid degradation of the polymer membranes under the action of the very high oxidizing power of the hydrogen peroxide solutions to be purified.

In addition to the need for polymer membranes that are resistant to the oxidative degradation inherent to hydrogen peroxide, the polymer membranes must also have a high rejection rate, in order to ensure optimum purification.

Today, there remains a need for membranes intended for the purification of hydrogen peroxide solutions, the lifetimes of which remain compatible with efficient and cost-effective uses on an industrial scale.

One objective of the present invention is consequently to provide polymer membranes for preparing hydrogen peroxide solutions of very high purity by reverse osmosis purification, said membranes having an improved lifetime compared to the polyamide-based membranes used today.

In addition to the need for polymer membranes that are resistant to the oxidative degradation inherent to hydrogen peroxide, the polymer membranes must also have a high rejection rate, in order to ensure optimum purification. Another objective of the present invention is therefore to provide polymer membranes for reverse osmosis purification of hydrogen peroxide, having improved stability over time and high rejection rates.

Thus, another objective of the present invention consists in providing polymer membranes having both an improved lifetime and a high rejection rate for use in the preparation of high-purity hydrogen peroxide solutions, which can be used in particular in the fields of cosmetics, pharmaceuticals, agri-food industry and electronics industry, in particular for the preparation of semiconductors and printed circuits.

Further objectives will become apparent in the description of the present invention that follows. The inventors have in fact discovered that the abovementioned objectives can be achieved in whole or at least in part, owing to specific polymer membranes which are particularly suitable for the purification of hydrogen peroxide solutions and the preparation of hydrogen peroxide solutions of very high purity.

Thus, and according to a first subject, the present invention relates to the use, for the purification of a hydrogen peroxide solution, of a reverse osmosis filtration membrane, said membrane comprising at least one active layer of a polymer of polyethersulfone (PES) type.

Specifically, it has been observed that PES-based polymer membranes have a substantially longer lifetime than those observed with polyamide-based polymer membranes, while offering a rejection rate which is very particularly suitable for the industrial production of hydrogen peroxide solutions of very high purity, and in particular of electronic grade hydrogen peroxide solutions.

In the present invention, the term “hydrogen peroxide solution” denotes an aqueous hydrogen peroxide solution. The concentration of hydrogen peroxide in water can vary to a large extent and is generally between 1% and 98%, preferably between 5% and 75%, for example between 10% and 70%, better still between 20% and 70%, advantageously between 30% and 70% by weight of hydrogen peroxide, relative to the total weight of the solution.

Polymers of polyethersulfone (PES) type are polymers that are well known to those skilled in the art and that comprise ether groups and sulfone groups. The polyethersulfones which have shown the best results in the use according to the present invention are PES comprising aromatic groups, commonly identified by the generic term polyarylethersulfones (PAES). The aromatic groups present in PAES are typically phenyl groups. The latter may be substituted, for example, with one or more sulfonate, amino, halogen (and more particularly fluorine), alkyl, alkenyl and other groups. In a very particularly preferred embodiment, the PES-type polymer for use according to the present invention is a polyarylethersulfone comprising at least one sulfonate group.

Such PES-type polymers which are very particularly suitable for the requirements of the present invention are polyarylethersulfones comprising at least one sulfonate group, as described, for example, in patent application US20200362107 A1.

It has in fact been discovered that reverse osmosis membranes comprising at least one filtration-active layer of a PES-type polymer, as defined above, impart a very good stability of the membranes over time, and very particularly when they are used for the purification of concentrated solutions, typically greater than 20% by weight and more specifically greater than 30% by weight, of hydrogen peroxide, while ensuring a high rejection rate, in order to ensure the purification thereof, to high-quality grades, ranging up to the electronic grade.

According to a very particularly preferred aspect of the present invention, the active polyethersulfone (PES) layer gives the reverse osmosis membrane a salt rejection rate of greater than 90%, preferably greater than 95%, more preferably greater than 97%, better still greater than 98%, advantageously greater than 99%. The rejection rate is measured on an aqueous solution containing 2000 mg per liter of sodium chloride, at 25° C., under a pressure of 15.5 bar (1.55 MPa), at pH 7, for 20 minutes, with a conversion rate of 15%, where the conversion rate is equal to the permeate flow rate/feed flow rate ratio.

Examples of membranes very particularly suitable for use according to the present invention comprise, by way of nonlimiting examples, homogeneous symmetric and asymmetric membranes and composite membranes. Composite membranes, and in particular TFC (thin-film composite) membranes, form a very particularly preferred subset of PES-based polymer membranes.

As indicated above, the membranes used in the context of the use according to the present invention comprise at least one filtration-active layer of a polymer of polyethersulfone (PES) type, preferentially of polyarylethersulfone (PAES) type, and very particularly of polyarylethersulfone (PAES) type bearing a sulfonate group. Among these membranes, homogeneous membranes are preferred. Another preferred group of membranes comprises composite membranes, for example of TFC type, comprising at least one filtration-active layer of a polymer of polyethersulfone (PES) type, in combination with one or more other polymer layers, for example layers of polyamide, polypiperazinamide, polyacrylonitrile, polysulfone, polyester (typically cellulose acetate), and others well known to those skilled in the art. However, due to the reasons mentioned above, it is preferable to use reverse osmosis membranes which do not comprise a polyamide layer.

Examples of TFC membranes that can be used in the present invention include membranes comprising two polyester and polysulfone support layers. Membranes very particularly suitable for the use according to the present invention are membranes in which the active layer is a polymer of polyethersulfone type, as indicated above, said active layer being combined with one or two polymer support layers chosen from polyester and polysulfone layers.

Such membranes have the advantages described above of being more stable over time than the membranes currently used for purifying hydrogen peroxide solutions, and in particular for purifying concentrated hydrogen peroxide solutions.

The use according to the present invention of a membrane comprising at least one polymer of polyethersulfone type as active layer makes it possible to obtain a good degree of purification of hydrogen peroxide solutions, while maintaining a good rejection rate. The use according to the present invention makes it possible to achieve high hydrogen peroxide purity qualities, in particular ranging up to the electronic grade. A person skilled in the art will be able to adapt, depending on the targeted grade and on the nature of the stream to be purified, the type of reverse osmosis membrane comprising at least one active layer of polyethersulfone type, for example BW (brackish water) or SW (sea water) membrane.

It has also been observed that membranes comprising at least one active layer of PES-type polymer withstand the oxidative attack of the hydrogen peroxide solutions much better than membranes with a polyamide active layer. This results in a very significant increase in the lifetime of said PES-based membranes.

This increase in the lifetime of the purification membranes, which it should be recalled, is today only a few days to a few weeks, leads to a significant reduction in the waste and in the operating costs associated with membrane replacement. The use according to the invention of membranes comprising at least one active layer of PES-type polymer therefore makes it possible to significantly improve the productivity of the system for producing high-purity hydrogen peroxide solutions, both in terms of costs and in terms of volumes treated.

According to a second aspect, the present invention relates to an industrial process for preparing hydrogen peroxide solutions of high purity, in particular of very high purity, and very particularly hydrogen peroxide solutions of electronic grade, i.e. where the very low level of impurities that they contain makes them compatible with the purity criteria required for use in the electronics industry.

The solutions purified by means of the process of the invention are aqueous hydrogen peroxide solutions generally with a concentration of between 1% and 98%, preferably between 5% and 75%, for example between 10% and 70%, better still between 20% and 70%, and more generally between 30% and 70% by weight of hydrogen peroxide, relative to the total weight of solution.

According to one embodiment, the high-purity hydrogen peroxide solutions are obtained from hydrogen peroxide, or even stabilized hydrogen peroxide, as available commercially. Commercial hydrogen peroxide is subjected to purification processes, which are well known and intended to remove impurities which are not acceptable for grades referred to as high-purity grades for use in particular in the cosmetics, pharmaceutical, agri-food and very particularly electronics fields. The process of the invention is also suitable for purifying concentrated hydrogen peroxide solutions, for example solutions obtained directly from the process for preparing said hydrogen peroxide.

Suitable purification processes well known to those skilled in the art comprise at least one step of reverse osmosis purification. According to the invention, the purification process comprises at least one step of reverse osmosis membrane purification, said membrane comprising at least one polyethersulfone-type polymer layer, as discussed above.

In addition to this reverse osmosis purification step, the process of the invention may comprise one or more other purification steps, selected from distillation, ion-exchange resin treatment, adsorption resin treatment, liquid-liquid extraction, electrodeionization (EDI) treatment, ultrafiltration, microfiltration, nanofiltration, and other purification techniques well known to those skilled in the art.

Generally, it is advantageous, in order to obtain very high degrees of purity, to combine one or more of the treatments indicated above. According to one embodiment of the invention, the process thus comprises at least one reverse osmosis treatment with a membrane comprising at least one PES-type active layer as defined above, an ion-exchange resin treatment and optionally an EDI treatment.

It has thus been discovered that the process of the present invention, owing to the use of a membrane with a PES-type active layer, makes it possible to obtain hydrogen peroxide solutions of high purity, or even of electronic grade, in a manner that is entirely viable and cost-effective on an industrial scale in terms of economic and commercial profitability.

More particularly, the process of the present invention is an industrial process for purifying and more particularly for producing hydrogen peroxide solutions of high purity, or even of very high purity, ranging from technical grade up to electronic grade, said process comprising at least the steps of:
a) providing a crude hydrogen peroxide solution to be purified,
b) treating said crude solution in a reverse osmosis membrane purification unit, said membrane comprising at least one active layer of polyethersulfone-type polymer,
c) recovering a permeate of purified hydrogen peroxide solution.

The expression “crude hydrogen peroxide solution to be purified” in step a) is understood to mean more specifically a hydrogen peroxide solution for which the degree of purity is to be increased. The hydrogen peroxide solutions to be purified may be of any type, both are commercial solutions for which the degree of purity is to be increased, to variable concentrations, as defined above, and also hydrogen peroxide solutions obtained from the synthesis process.

Processes for the synthesis, for example the industrial synthesis, of hydrogen peroxide solutions are well known to those skilled in the art or are easily accessible in the literature and on the Internet. One process that is very particularly and commonly used today is the process referred to as the anthraquinone process. The hydrogen peroxide solutions thus obtained and which are used in the process of the present invention are generally and most commonly aqueous hydrogen peroxide solutions which have a concentration of approximately 60% to 70% by weight. Stabilizers, also well known to those skilled in the art, may optionally be added to these solutions.

The reverse osmosis purification step b) may itself be carried out one or more times, in series or in parallel, with or without direct recycling of the concentrated permeate. It is thus possible to carry out one, two or more reverse osmosis membrane purification steps, for example by recovery of the permeate and a fresh purification step using said membrane. According to one embodiment, the process can thus comprise from 1 to 5, preferably from 1 to 4, more preferably 1, 2 or 3, advantageously 1 or 2 membrane purification steps.

According to one embodiment, the process of the present invention may also comprise, in addition, one or more complementary purification steps, according to other techniques well known to those skilled in the art and which may, for example, and in a nonlimiting manner, be selected from distillation, ion-exchange resin treatment, adsorption resin treatment, liquid-liquid extraction, electrodeionization (EDI) treatment, ultrafiltration, microfiltration, nanofiltration, and the like, as indicated above. Among these complementary techniques, EDI purification techniques and ion-exchange resin purification techniques are preferred.

It should be understood that one or more of these complementary purification techniques can be carried out before and/or after the reverse osmosis purification using the membrane according to the present invention. Thus, and according to one embodiment of the process of the invention, this process comprises at least one reverse osmosis purification step using a membrane as defined above, with a polyethersulfone-type polymer active layer, and at least one purification step by passing through an ion-exchange resin. According to another embodiment, the purification process of the invention comprises at least one reverse osmosis purification step using a membrane as defined above, with a polyethersulfone-type polymer active layer, at least one purification step by passing through an ion-exchange resin and at least one purification step using the EDI technique.

The ion-exchange resin purification step generally makes it possible to reach even higher degrees of purity. If desired, this ion-exchange resin treatment can be carried out one or more times, in series or in parallel.

The ion-exchange resins which may be used are well known to those skilled in the art and may, for example, be chosen from those of the strong cation type, and for example and nonlimitingly from the Amberlite™ 200C and Amberjet™ 1500H resins from Rohm & Haas.

If it is desirable, the purification process of the present invention may also comprise one or more nanofiltration and/or microfiltration and/or ultrafiltration steps, well known to those skilled in the art. Microfiltration and/or nanofiltration and/or ultrafiltration can make it possible to remove, if necessary, particles which may be present in the hydrogen peroxide solutions. These additional purification operations by ultrafiltration and/or nanofiltration and/or microfiltration are themselves well known to those skilled in the art and can be carried out one or more times, in series or in parallel, before and/or after the reverse osmosis membrane purification step(s) described above.

Thus, the process of the invention carrying out at least one purification step using a membrane comprising at least one polyethersulfone-type polymer active layer, as defined above, is very particularly effective for obtaining hydrogen peroxide solutions of very high purity, and in particular for the purification of concentrated solutions, of the order of 60% to 70% by weight. The process of the invention is particularly suitable for the industrial production of electronic grade hydrogen peroxide. Said process is also particularly easy to implement and cost-effective owing to the high strength of the reverse osmosis membranes, unlike the membranes commonly used in this application.

1-9. (canceled)

10. The use, for the purification of a hydrogen peroxide solution, of a reverse osmosis filtration membrane, said membrane comprising at least one active layer of a polyethersulfone-type polymer.

11. The use as claimed in claim 10, wherein the polyethersulfone-type polymer is a polyarylethersulfone-type polymer.

12. The use as claimed in claim 10, wherein the membrane has a salt rejection rate of greater than 90%, said rejection rate being measured on an aqueous solution containing 2000 mg per liter of sodium chloride, at 25° C., under a pressure of 1.55 MPa, at pH 7, for 20 minutes, with a conversion rate of 15%, where the conversion rate is equal to the permeate flow rate/feed flow rate ratio.

13. The use as claimed in claim 10, wherein the membrane is a membrane chosen from homogeneous symmetric and asymmetric membranes and composite membranes.

14. The use as claimed in claim 10, wherein the membrane comprises at least one filtration-active layer of a polymer of polyethersulfone (PES) type, in combination with one or more other polymer layers, selected from polyamide, polypiperazinamide, polyacrylonitrile, polysulfone and polyester.

15. A process for purifying a hydrogen peroxide solutioncomprising at least one step of reverse osmosis membrane filtration with a reverse osmosis filtration membrane, said membrane comprising at least one polyethersulfone-type polymer active layer.

16. The process as claimed in claim 15, comprising at least the steps of:
a) providing a crude hydrogen peroxide solution to be purified,
b) treating said crude solution in a reverse osmosis membrane purification unit, said membrane comprising at least one active layer of polyethersulfone-type polymer, and
c) recovering a permeate of purified hydrogen peroxide solution.

17. The process as claimed in claim 16, wherein the reverse osmosis purification step b) is carried out one or more times, in series or in parallel, with or without direct recycling of the concentrated permeate.

18. The process as claimed in claim 15, further comprising one or more complementary purification steps, selected from distillation, ion-exchange resin treatment, adsorption resin treatment, liquid-liquid extraction, electrodeionization (EDI) treatment, ultrafiltration, microfiltration, and nanofiltration.

19. The process as claimed in claim 15, wherein the hydrogen peroxide solution is an electronic grade hydrogen peroxide solution.

20. A reverse osmosis filtration membrane configured for purification of a hydrogen peroxide solution, said membrane comprising at least one active layer of a polyethersulfone-type polymer.
